(19) United States
(12) Patent Application Publication
(10) Pub. No.: US 2005/0237608 A1
(43) Pub. Date: Oct. 27, 2005

(54) Binocular telescope

(76) Inventor: Haruhiko Yamanouchi, Kanagawa-ken (JP)

Correspondence Address: MORGAN & FINNEGAN, L.L.P., 3 WORLD FINANCIAL CENTER, NEW YORK, NY, 10281-2101, US

(21) Appl. No.: 11/114,743

(22) Filed: Apr. 25, 2005

(30) Foreign Application Priority Data
Apr. 26, 2004 (JP) 2004-129903

(51) Int. Cl. G02B 23/00

(52) U.S. Cl. 359/409; 359/407

(57) ABSTRACT

To provide a binocular telescope including: a pair of objective optical systems; two cover members arranged in a first direction perpendicular to a plane defined by optical axes of the pair of objective optical systems, the two cover members being connected to form a cover unit, the cover unit substantially covering the pair of objective optical systems; and a reinforcing member connected to both the two cover members, the reinforcing member reducing deformation of the cover unit in the first direction.

### BACKGROUND OF THE INVENTION

1. Field of the Invention

The present invention relates to a binocular telescope, in particular, a binocular telescope having a reinforcing member inside a main body thereof.

2. Related Background Art

Conventionally, closed-type binocular telescopes have been known as binocular telescopes with a waterproof function. In most of the closed-type binocular telescopes, such as one disclosed in Japanese Patent Application Laid-Open No. H07-209589, a cover unit holding left and right optical systems is mainly formed in substantially a cylindrical or a columnar shape.

In recent years, in accordance with diversification of external designs, a so-called vibration prevention binocular telescope having a hand vibration correction mechanism is increasing in number. In the vibration prevention binocular telescope, a principal portion of a main body is constituted such that an objective lens section and a hand vibration correction mechanism section are integrated because of characteristics of a hand vibration correction mechanism mounted on the binocular telescope.

In such a binocular telescope, as disclosed in, for example, Japanese Patent Application Laid-Open No. 2003-222921, the principal portion of the main body includes two housings having a flat shape expand integrally to the left and right in a horizontal direction.

In such housings of the flat shape, when a closed structure is adopted to realize the waterproof function, the upper housing and the lower housing extending in the horizontal direction bear a pressure difference between the inside and the outside of the binocular telescope caused by environmental changes in temperature and an atmospheric pressure. Thus, conventionally, the housings are generally made of a durable material such as a metal material.

On the other hand, recently, in some of the binoculars, the principal portion of the main body is made of a resin material.

However, in the conventional closed-type binocular telescope, even if a metal material is used for the cover member, it is necessary to considerably increase the thickness of the cover member in order to bear the pressure difference. Therefore, the weight of the binocular telescope increases and its manufacturing cost also increases.

On the other hand, in the closed-type vibration prevention binocular telescope using the resin material in the cover member, when the pressure difference between the inside and the outside of the binocular telescope occurs because of the environmental changes in temperature and an atmospheric pressure, upper and lower surfaces extending in the horizontal direction bend. If the upper and lower surfaces are pressed strongly, the upper and lower surfaces curve to cause a gap in parallelism of optical axes in the left optical system and the right optical system of the binocular telescope.

### SUMMARY OF THE INVENTION

In order to solve the above-mentioned problems, according to one aspect of the invention, a binocular telescope includes: a pair of objective optical systems; two cover members arranged in a first direction perpendicular to a plane defined by optical axes of the pair of objective optical systems, the two cover members being connected to form a cover unit, the cover unit substantially covering the pair of objective optical systems; and a reinforcing member connected to both the two cover members, the reinforcing member reducing deformation of the cover unit in the first direction.

Further, in order to solve the above-mentioned problems, according to another aspect of the invention, a binocular telescope includes: a pair of objective optical systems; two cover members arranged in a first direction perpendicular to a plane defined by optical axes of the pair of objective optical systems, the two cover members being connected to form a cover unit, the cover unit substantially covering the pair of objective optical systems; and a reinforcing member connected to both the two cover members, the reinforcing member being arranged to traverse between two optical axes of the pair of objective optical systems and spaced apart from the cover unit in a section of the binocular telescope on the plane.

According to further another aspect of the invention, a binocular telescope includes: a pair of objective lenses; a cover member that covers an outer side of a main body of the binocular telescope while extending across optical axes of the pair of objective lenses; and a reinforcing portion that is formed in the inside of the main body and connects an upper cover unit and a lower cover unit between an upper part and a lower part across the optical axes of the cover member to each other.

According to further another aspect of the invention, a binocular telescope includes: a pair of objective optical systems; a cover unit which is provided so as to cover optical axes of both of the pair of objective optical systems; and a reinforce member which is provided to suppress a deformation of the cover unit, in a first direction perpendicular to a plane defined by the optical axes of the pair of objective optical systems.

According to further another aspect to the invention, a binocular telescope includes: a pair of objective optical systems; a cover unit which is provided so as to cover optical axes of both of the pair of objective optical systems; and a reinforce member which is connected with the cover unit at two positions where are different from each other in a first direction perpendicular to a plane defined by the optical axes of the pair of objective optical systems, wherein the reinforce member is located to across between the two optical axes of the pair of objective optical systems.

### BRIEF DESCRIPTION OF THE DRAWINGS

FIG. 1 is a horizontal sectional view of a closed-type binocular telescope viewed from above according to an embodiment of the present invention;

FIG. 2 is a vertical sectional view of the closed-type binocular telescope viewed from a side thereof according to the embodiment of the present invention;

FIG. 3A is an enlarged view of a joint portion of an upper outer cover and a lower outer cover; and

FIG. 3B is a further enlarged view of the periphery of projected portions 26 shown in FIG. 3A.

### DETAILED DESCRIPTION OF THE PREFERRED EMBODIMENT

A best mode for carrying out the present invention will be hereinafter explained.

In an embodiment of the invention, the constitution of the invention is applied to provide a closed-type vibration prevention binocular telescope that has a waterproof function including a closed structure and is mounted with a vibration prevention mechanism (a hand vibration correction mechanism) using a so-called vari-angle prism (VAP) for image blur correction.

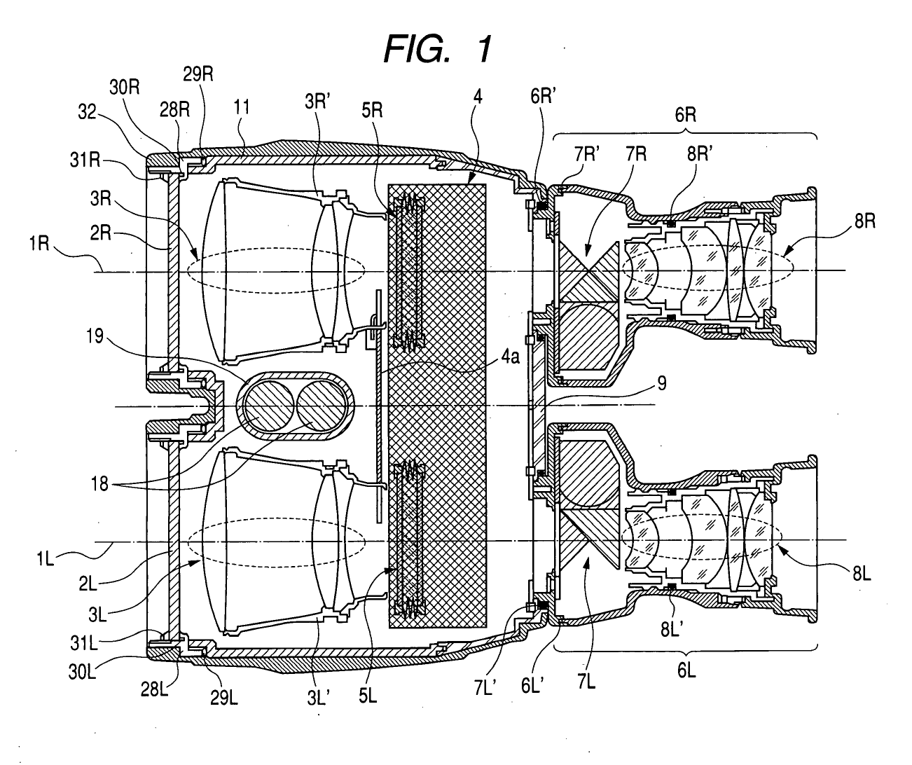

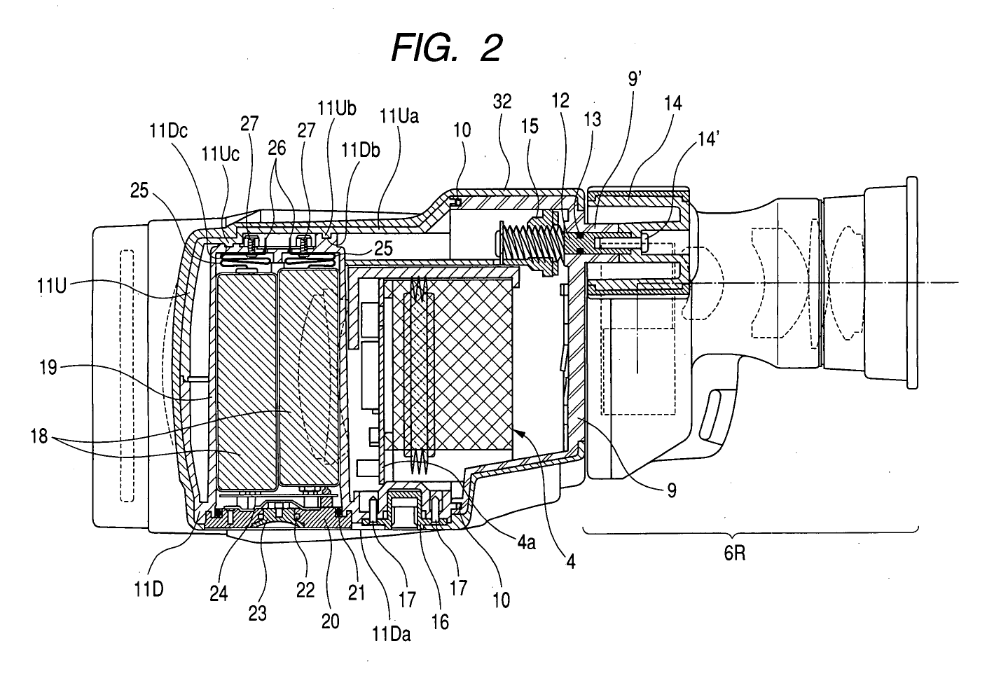

FIG. 1 is a horizontal sectional view of the closed-type binocular telescope viewed from above according to this embodiment. FIG. 2 is a vertical sectional view of the closed-type binocular telescope viewed from a side thereof according to this embodiment.

In the binocular telescope shown in FIGS. 1 and 2, a cover of a binocular telescope main body includes an upper cover member (an upper outer cover 11U in FIG. 2) and a lower cover member (a lower outer cover 11D in FIG. 2) that cover a pair of objective lenses so as to extend across optical axes of the objective lenses. An upper cover unit and a lower cover unit, which are arranged above and below the optical axes of the pair of objective lenses, are connected by a battery loaded portion formed in the binocular telescope main body, whereby the cover formed by the upper cover member and the lower cover member is reinforced in a top-to-bottom direction. Here, a member for the reinforcement (hereinafter referred to as reinforcing member) is desirably formed to connect a flat portion of the upper cover member and a flat portion of the lower cover member (i.e., portions that tend to bend when a pressure difference between the inside and the outside of the binocular telescope occurs, specifically, a portion between the optical axes of the pair of objective lenses in the upper cover member and a portion between the optical axes of the pair of objective lenses in the lower cover member) rather than being provided in a peripheral portion of the upper cover member and the lower cover member. In other words, the reinforcing member is desirably formed to traverse between the optical axes of the pair of objective lenses.

It is needless to mention that the reinforcing member is not limited to the battery loaded portion and other members may be used as the reinforcing member. However, in the case of the binocular telescope having the image blur correction mechanism as in this embodiment, the battery loaded portion is essential. In that case, the battery loaded portion is formed to function as a reinforcing portion, which makes it unnecessary to provide separate members as the reinforcing member and the battery loaded portion. Thus, it is possible to reduce the number of components and simplify the structure of the binocular telescope.

Next, a specific structure of the binocular telescope will be explained with reference to FIGS. 1 and 2.

In FIG. 1, symbols 1R and 1L denote a pair of left and right objective optical axes. On the pair of left and right objective optical axes 1R and 1L, as optical systems, protective glasses 2R and 2L that are parallel flat plates, objective lens units 3R and 3L held by objective lens barrels 3R′ and 3L′, vari-angle prism (VAP) element units 5R and 5L provided in a vibration prevention mechanism (a hand vibration correction mechanism) 4 holding a vibration prevention drive control board 4a, and ocular units 6R and 6L are arranged on the left and right, respectively, in order from an object side.

In the ocular units 6R and 6L, erecting prism units 7R and 7L and ocular optical systems 8R and 8L are arranged in predetermined positions, respectively, as shown in FIG. 1. In addition, the ocular unit 6R and the ocular unit 6L are entirely held on an ocular base 9 so as to be rotatable in fixed positions around the objective optical axes 1R and 1L, respectively.

Optical axes of the ocular optical systems 8 are arranged in positions translated from the objective optical axes 1 because of characteristics of the erecting prism units 7 (see FIG. 2). Thus, it is possible to suit a width between the ocular optical systems 8R and 8L to a width between eyes of an observer (not shown) by rotating the ocular units 6R and 6L, respectively, as described above.

Next, a structure of a main body mechanism will be explained.

A groove (a recess) is formed over an entire periphery of a front end surface (an end surface on the object lens side) of the ocular base 9. A seal ring 10 is arranged in the groove over the entire periphery along the groove without a break.

As shown in FIG. 2, a fitting hole 9′ is provided in parallel with the optical axes slightly above a plane portion at a rear end of the ocular base 9. A focus screw 12 is held in the fitting hole 9′ together with an O ring 13. The focus screw 12 and the O ring 13 are held so as to be rotatable in a fixed position relatively to the ocular base 9.

A screw portion formed in a front half of the focus screw 12 is screwed with a nut 15 provided in an objective moving mechanism (not shown) that makes the objective optical systems 3R and 3L movable in an optical axis direction simultaneously. Therefore, it is possible to move the objective optical systems 3R and 3L in the optical axis direction simultaneously by rotating the focus screw 12 and realize focusing of the binocular telescope. Note that actual focus operation is performed by rotating a focus dial screwed by a machine screw 14′ in the rear of the focus screw 12.

Inner spaces of the ocular units 6R and 6L communicate with an inner space on a main body side (a side including the objective lenses and the vibration prevention mechanism) through a hole provided in the ocular base 9. Here, it is possible to keep sealing property of the inner space on the main body side and the inner space on the ocular optical system side by using O rings 6R′ and 6L′ provided in a holding portion of the ocular units 6R and 6L of the main body and seal rings 7R′ and 7L′ and O rings 8R′ and 8L′ provided on the side of a housing supporting the ocular optical systems.

An outer cover 11 is made of a resin material and an entire peripheral brim portion is formed at a rear end of the outer cover 11. The entire peripheral brim portion at the rear end is screwed by a machine screw (not shown) from the rear of the ocular base 9 so as to be in press-contact with the seal ring 10. Thus, it is possible to keep sealing property of this portion.

As shown in FIG. 2, the outer cover 11 is divided into two components, namely, the upper outer cover 11U and the lower outer cover 1D. The upper outer cover 11U and the lower outer cover 11D are firmly bonded together in substantially horizontal portions thereof and integrated.

In addition, since the outer cover 11 is made of the resin material, a metal plating layer is formed over substantially an entire surface of the components in order to prevent penetration of water vapor (however, the vicinity of an electrode 25 described later is masked to be prevented from being plated at the time of plating and, instead, an exposed portion of the resin material is filled with an insulating sealing member).

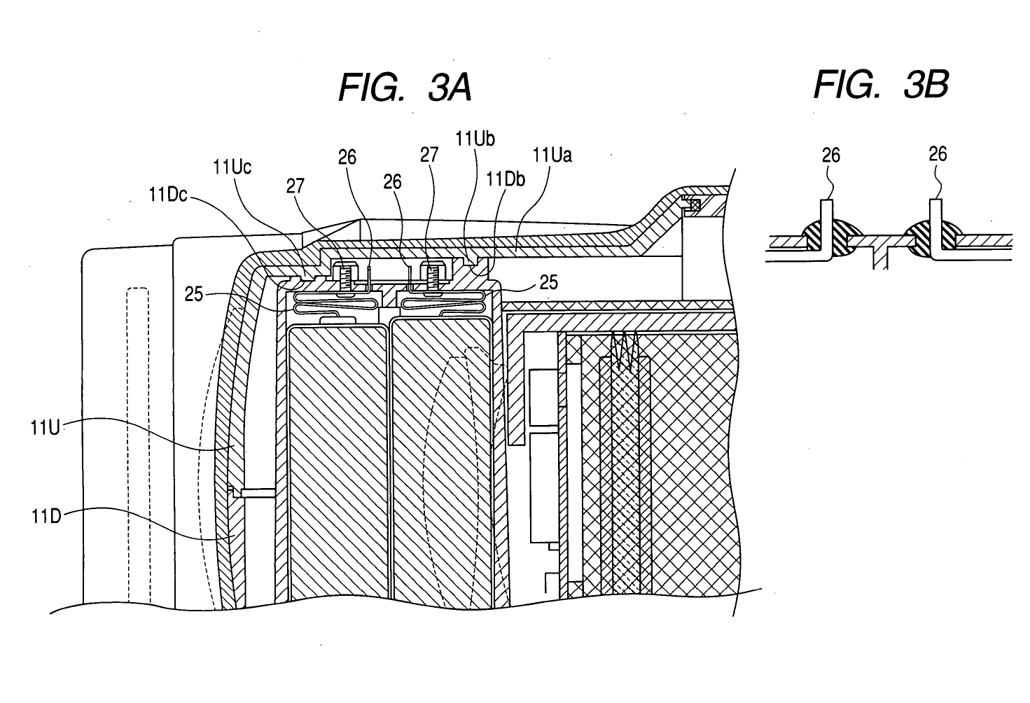

FIG. 3A shows a detailed view of a joint portion of the upper outer cover and the lower outer cover. Here, the upper outer cover 11U has a substantially plane portion 11Ua, which expands to the front and rear and the left and right, on an upper surface portion thereof. Two convex portions 11Ub and 11Uc are formed on an inner surface side of the substantially plane portion 11Ua or near the inner surface side. In addition, the lower outer cover 11D has a substantially plane portion 11Da, which expands to the front and rear and the left and right in the same manner as the substantially plane portion 11Ua of the upper outer cover 11U, on a lower surface portion thereof.

A tripod seat attaching screw member 16 is screwed behind the substantially plane portion 11Da by plural machine screws 17. A battery loaded portion 19, which can be loaded with two batteries 18 and is projected in a direction of the upper outer cover 11U (a direction of the substantially plane portion 11Ua of the upper outer cover), is integrally molded in front of the substantially plane portion 11Da. Two recessed portions 11Db and 11Dc are formed in an uppermost portion of the battery loaded portion 19. The recessed portions 11Db and 11Dc engage with the two convex portions 11Ub and 11Uc formed on the inner surface side of the upper outer cover 11U or near the inner surface side. Here, in order to connect the upper outer cover and the lower outer cover firmly, an engaging portion of the convex portion 11Ub and the recessed portion 11Db and an engaging portion of the convex portion 11Uc and the recessed portion 11Dc are joined firmly by an adhesive or the like.

An open-close battery cover 20 covering an entrance in a lower surface of the battery loaded portion 19 is provided in the battery loaded portion 19. An O ring 21 for waterproofing the inside of the battery loaded portion 19 is provided in contact with the entrance in the lower surface of the battery loaded portion 19 around the battery cover 20.

A battery cover open-close dial 22 having an O ring 23 is set in the center of the battery cover 20 such that the battery cover 20 can maintain a closed state. Moreover, a common electrode 24, which is in contact with the two batteries 18 simultaneously, is provided on an inner side of the battery cover 20.

On the other hand, as shown in FIG. 3B, two electrodes 25, which are provided with projected portions 26 for applying an electric current from small holes in an innermost part of the battery loaded portion 19 to the inside of the battery loaded portion 19, are fixed to the innermost part of the battery loaded portion 19 in contact with the two batteries 18, respectively, by machine screws 27. Here, the small holes are holes (small holes) for passing projected portions for soldering the electrodes 25 from the battery loaded portion 19 to the inside of the binocular telescope. Finally, the small holes are filled with an insulating sealing member.

Note that, as described above, in the vicinity of the electrodes 25 (e.g., an area including the vicinity of a portion where the electrodes 25 are in contact with the lower cover and the periphery of the small holes in the innermost part of the battery loaded portion 19, the machine screws 27, and the like), an insulating sealing member for keeping sealing property fills a space between the projected portions 26 of the electrodes 25 and the small holes in the innermost part of the battery loaded portion 19.

A pair of left and right objective frames 28R and 28L are screwed at tips on the left and right of the upper outer cover 11U. O rings 29R and 29L are arranged in the objective frames 28R and 28L, respectively, to make it possible to keep sealing property in this portion. O rings 30R and 30L and the protective glasses 2R and 2L, which are parallel flat plates, are arranged on the inner side in the front of the pair of left and right objective frames 28R and 28L. The O rings 30R and 30L and the protective glasses 2R and 2L are screwed in and, at the same time, brought into press-contact with and fixed to the objective frames 28R and 28L by a pair of pressing rings 31R and 31L. Thus, sealing property is kept in this portion.

An outer cover 32 is made of a rubber member (or a member other than the rubber member as long as the member has elasticity) so as to cover the main body portion. The outer cover 32 is arranged for protection against an impact from the outside or for tidying a design as a binocular telescope. In general, a rubber shape has many openings and, in this embodiment, the rubber material and the outer cover 11 are simply bonded together in a predetermined several sections. Thus, the outer cover 32 hardly contributes to sealing property in an inner space of the binocular telescope and to measures against an atmospheric pressure difference between the inside and the outside of the binocular telescope.

Next, a structure and an operation of the vibration prevention mechanism will be explained.

An electric current from the two batteries 18 loaded in the battery loaded portion 19 is guided from the small holes in the innermost part of the battery loaded portion 19 to the inside thereof through the respective electrodes 25. Then, the electric current is supplied to the vibration prevention drive control board 4a held by the vibration prevention mechanism 4 by a lead wire (not shown) or the like.

On the other hand, when an electric operation switch (not shown) for starting a vibration prevention operation is turned ON, application of an electric current to the vibration prevention drive control board 4a is started. Then, the vibration prevention drive control board 4a drives the publicly-known VAP element units 5R and 5L provided in the vibration prevention mechanism 4 to prevent vibration while processing a signal of a hand vibration sensor (not shown) such as a vibration gyro mounted on the vibration prevention drive control board 4a.

When the vibration prevention mechanism (the hand vibration correction mechanism) is mounted, in particular, a surface extending across the left and right optical axes tends to be formed in the upper and lower portions of the cover members of the binocular telescope. Thus, the. reinforcing structure of the invention is effective.

In the closed-type binocular telescope of this embodiment having the structure described above, the O rings and the sealing rubber are arranged in the joints of the cover components or the insulating sealing member fills spaces in portions exposed from plating of the resin material, the vicinity of the electrodes, and the like to realize a completely closed structure.

In the explanation of this embodiment, the battery loaded portion is set as the reinforcing portion that connects the surfaces of the upper and lower parts of the cover member (the upper cover member and the lower cover member) of the closed-type binocular telescope in the inside of the closed-type binocular telescope. When the battery loaded portion or the like is also used as a reinforcing structure, it is possible to realize a reduction in weight of the binocular telescope at lower cost without adding new reinforcing members. It is needless to mention that such a structure may be adopted as a modification of this embodiment, in which strength in the top-to-bottom direction of the cover member obtained by combining the upper cover member and the lower cover member (in other words, an arrangement direction of the two cover members or a connecting direction of the two cover members) can be supplemented using a member other than the battery loaded portion. For example, a simple columnar member may be used. Two tabular members crossing each other viewed from above may be used to connect the upper cover member and the lower cover member to further reinforce the cover member (it is needless to mention that a columnar member having an X shape viewed from above may be used). Alternatively, one plate (or plural plates), which is (are) arranged in parallel with optical axes of a pair of objective lenses and in parallel with a normal of a plane defined by the two optical axes of the pair of objective lenses, may be used. However, even when such a modification is adopted, it is desirable that the reinforcing member be arranged between the optical axis of the pair of objective lenses (i.e., the reinforcing member is arranged to traverse between the optical axes of the pair of objective lenses).

The term “reinforcing member” in this embodiment is a member for, when a cover unit is generally formed by an upper outer cover (an upper cover member) and a lower outer cover (a lower cover member), supplementing strength of the cover unit against an external force from the outside of an apparatus (in particular, a force pressing the apparatus from the outside to the inside or a force pressing the apparatus from the inside to the outside), which is caused by an atmospheric pressure difference or the like in the inside and the outside of the apparatus, in the arrangement direction of the two cover members (in this embodiment, the top-to-bottom direction). Particularly in a binocular telescope, a member for supplementing strength of a cover unit against an external force in a direction perpendicular to both optical axes of a pair of object lenses (a force pressing the binocular telescope from the outside to the inside or a force pressing the binocular telescope from the inside to the outside) is called a reinforcing member. More specifically, the reinforcing member in this embodiment means a member for reducing an amount of deformation toward the inside of the apparatus (or the outside of the apparatus) due to an external force in the respective upper cover member and lower cover member.

In addition, in this embodiment, the battery loaded portion functions as the reinforcing member. The battery loaded portion is constituted as a part of the lower outer cover (the lower cover member). However, it is needless to mention that the reinforcing member (the battery loaded portion) may be provided as a member separate from the upper outer cover and the lower outer cover.

Therefore, the rubber member or the like may have a function of tightening connection among plural members constituting the cover unit. However, since the rubber member does not have the function described above, the rubber member is not referred to as the reinforcing member in this embodiment.

A pressure difference between the inside and the outside of the closed-type binocular telescope due to a change in an environment of use of the closed-type binocular telescope is considered. It is assumed that the binocular telescope is manufactured at temperature of 20° C. and an atmospheric pressure of 1 atom as an environment at the time of manufacturing (when the binocular telescope is sealed). When temperature is 0° C. or 40° C. under 1 atom as an environment of use, since the number of moles of gas in the binocular telescope does not change and only temperature changes, a pressure difference between the gas and the outside air (which is assumed to be 1 atom) is about 0.068 atom. Thus, a pressure difference is about 70 grams per one centimeter. This means that, if an area of the plane portion is 100 square centimeters, the pressure difference reaches 7 kilograms. If a change in environmental temperature is larger than this or a fluctuation in the atmospheric pressure occurs in addition to the change in temperature, a pressure difference due to an atmospheric pressure of about 10 kilograms in 100 square centimeters is realistic enough. The cover member of the closed-type binocular telescope in this embodiment is mainly made of a resin material. However, since the battery loaded portion 19 extends to the upper outer cover 11U and bonded, sudden deformation of the cover member is less likely to occur even if a pressure in this order is applied thereto. Thus, it is possible to suppress a change in parallelism of optical axes in the left optical system and the right optical system, occurrence of deficiency in the vibration prevention mechanism, and the like.

Even when a cover member made of a metal material is used as in the conventional waterproof binocular telescope instead of the resin used in the embodiment, it is possible to reduce the thickness of the metal material of the cover member and attain a reduction in weight and cost if the reinforcing member is provided between the upper and lower surfaces.

As described above, according to this embodiment, it is possible to provide an optical apparatus (e.g., a binocular telescope) that can be made of an inexpensive material, has less occurrence of optical axis shift or the like, and has high strength.

Furthermore, according to this embodiment, an upper cover unit, a lower cover unit, and a reinforce member (corresponding to a battery loaded portion in the embodiment) are described as members independently provided basically. However, it is also described that the lower cover unit and the reinforce member are integrally molded. In the same token, the upper cover unit and the lower cover unit may be integrally formed, the upper cover unit, the lower cover unit, and the reinforce member may be integrally formed, or two of the upper cover unit, the lower cover unit, and the reinforce member may be integrally formed. In a case that an arrangement wherein the inside of the binocular telescope is sealed from the ambient air is required, it is preferable to integrally form the upper cover unit and the lower cover unit. In such arrangement, there is no connection between the upper cover unit and the lower cover unit, from which the ambient air goes into the inside of the binocular telescope.

This application claims priority from Japanese Patent Application No. 2004-129903 filed Apr. 26, 2004, which is hereby incorporated by reference herein.

1. A binocular telescope, comprising:
a pair of objective optical systems;
two cover members arranged in a first direction perpendicular to a plane defined by optical axes of the pair of objective optical systems,
the two cover members being connected to form a cover unit,
the cover unit substantially covering the pair of objective optical systems; and
a reinforcing member connected to both the two cover members,
the reinforcing member reducing deformation of the cover unit in the first direction.

2. A binocular telescope according to claim 1, wherein the reinforcing member traverses between two optical axes of the pair of objective optical systems.

3. A binocular telescope according to claim 1, wherein the reinforcing member also serves as a battery loaded portion.

4. A binocular telescope according to claim 1, wherein the reinforcing member is spaced apart from (is not in contact with) the cover unit of the binocular telescope in a section of the binocular telescope on the plane.

5. A binocular telescope according to claim 1, wherein the two cover members are made of a resin material.

6. A binocular telescope, comprising:
a pair of objective optical systems;
two cover members arranged in a first direction perpendicular to a plane defined by optical axes of the pair of objective optical systems,
the two cover members being connected to form a cover unit,
the cover unit substantially covering the pair of objective optical systems; and
a reinforcing member connected to both the two cover members,
the reinforcing member being arranged to traverse between two optical axes of the pair of objective optical systems and spaced apart from the cover unit in a section of the binocular telescope on the plane.

7. A binocular telescope according to claim 6, wherein the reinforcing member also serves as a battery loaded portion.

8. A binocular telescope according to claim 6, wherein the two cover members are made of a resin material.

9. A binocular telescope, comprising:
a pair of objective lenses;
a cover member that covers an outer side of a main body of the binocular telescope while extending across optical axes of the pair of objective lenses; and
a reinforcing portion that is formed in the inside of the main body and connects an upper cover unit and a lower cover unit between an upper part and a lower part across the optical axes of the cover member to each other.

10. A binocular telescope according to claim 9, wherein the outer side of the main body is formed in a closed structure by the cover member or the like.

11. A binocular telescope according to claim 9, wherein the reinforcing portion is formed between the optical axes of the pair of objective lenses.

12. A binocular telescope according to claim 9, wherein the reinforcing portion is formed to also serve as a battery loaded portion inside the main body.

13. A binocular telescope according to claim 9, wherein the cover member is mainly formed of a resin material.

14. A binocular telescope according to claim 9, wherein an external shape of the binocular telescope is formed in a flat shape in which upper and lower portions are longer than a side portion.

15. A binocular telescope according to claim 9, further comprising a hand vibration correction mechanism.

16. A binocular telescope comprising:
a pair of objective optical systems;
a cover unit which is provided so as to cover optical axes of both of the pair of objective optical systems; and
a reinforce member which is provided to suppress a deformation of the cover unit, in a first direction perpendicular to a plane defined by the optical axes of the pair of objective optical systems.

17. A binocular telescope according to claim 16, wherein the reinforce member is connected with the cover unit at two positions where are different from each other in the first direction.

18. A binocular telescope according to claim 16, wherein the reinforce member is located to across between the two optical axes of the pair of objective optical systems.

19. A binocular telescope comprising:
a pair of objective optical systems;
a cover unit which is provided so as to cover optical axes of both of the pair of objective optical systems; and
a reinforce member which is connected with the cover unit at two positions where are different from each other in a first direction perpendicular to a plane defined by the optical axes of the pair of objective optical systems,
wherein the reinforce member is located to across between the two optical axes of the pair of objective optical systems.

20. A binocular telescope according to claim 19, wherein in a section of the binocular telescope along the plane, the reinforce member is located apart from the cover unit.
